(19) United States
(12) Patent Application Publication
(10) Pub. No.: US 2010/0124878 A1
(43) Pub. Date: May 20, 2010

(54) METHOD AND APPARATUS FOR BROADCAST MESSAGE DISCRIMINATION

(76) Inventors: Stuart O. Goldman, Scottsdale, AZ (US); Carlos Solari, Shenandoah, VA (US)

Correspondence Address: FAY SHARPE/LUCENT, 1228 Euclid Avenue, 5th Floor, The Halle Building, Cleveland, OH, 44115-1843, US

(21) Appl. No.: 12/274,487

(22) Filed: Nov. 20, 2008

(51) Int. Cl. H04H 20/71

(52) U.S. Cl. 455/3.01

(57) ABSTRACT

A method for broadcast message discrimination may include: a) forming a first version of a broadcast message with first encoding associated with a first recipient group and a second version of the broadcast message with second encoding associated with a second recipient group, b) transmitting the first and second versions of the broadcast message over a coverage area, c) receiving the first and second versions of the broadcast message at a first receiving device selectively associated with the first recipient group and at a second receiving device selectively associated with the second recipient group, and d) delivering the first version of the broadcast message via the first receiving device and the second version of the broadcast message via the second receiving device. A communication system for broadcast message discrimination may include a communication network, a first receiving device, and a second receiving device.

### BACKGROUND

This disclosure relates to a method and apparatus for broadcast message discrimination in a communication system. While this disclosure describes exemplary embodiments of broadcast message discrimination in a communication system, and will be thus described with specific reference thereto, it will be appreciated that the disclosed concepts may have usefulness in many types of communication systems. For example, the concepts may be useful in any television, radio, telephone, or computer communication system in which a message may be broadcast to users or subscribers having varying relation to the message content.

A satellite communication system may include a satellite that may transmit a broadcast message over a large area with respect to geography, demography, or another parameter that varies in relation to users or subscribers. For example, one geostationary satellite may illuminate the entire continental United States. Another geostationary satellite may illuminate most of the western hemisphere.

A message that is broadcast over a large area may have varying applicability to recipients. For example, an emergency broadcast message relating to a hurricane or a tornado may be delivered to people outside the immediate crisis area. This may cause needless concern or panic in areas not affected by the crisis. Moreover, it may reduce the vigilance of people taking heed of the warning due to prior “false” alarms. Authorities may even be reluctant to use the communication system to broadcast messages for localized warnings due to some of these negative impacts across the larger population.

Accordingly, it is problematic to use a communication system to transmit broadcast messages for a localized segment to all users within the coverage area. Typically, current communication technologies are “all or none.” For example, the geostationary satellite either transmits the broadcast message or it doesn't. If transmitted, the broadcast message is received by all receiving devices within the footprint of the coverage area.

Based on the foregoing, a solution that discriminates messages broadcast to users based on some criteria (e.g., relating the message to the recipient) is desirable. Additionally, a solution that that overcomes at least a portion of the drawbacks associated with known approaches to broadcast messages via current communication systems is desirable.

### SUMMARY

In one aspect a method for broadcast message discrimination is provided. In one embodiment, the method includes: a) forming a first version of a broadcast message with first encoding associated with a first recipient group and a second version of the broadcast message with second encoding associated with a second recipient group, b) transmitting the first and second versions of the broadcast message over a coverage area, c) receiving the first and second versions of the broadcast message at a first receiving device selectively associated with the first recipient group and at a second receiving device selectively associated with the second recipient group, and d) delivering the first version of the broadcast message via the first receiving device and the second version of the broadcast message via the second receiving device.

In another embodiment, the method includes: a) forming a first version of an emergency broadcast message with first geographic encoding associated with a first recipient group and a second version of the emergency broadcast message with second geographic encoding associated with a second recipient group, b) transmitting the first and second versions of the emergency broadcast message from a geostationary satellite over a coverage area, wherein the first geographic encoding and first recipient group are associated with a first portion of the coverage area and the second geographic encoding and second recipient group are associated with a second portion of the coverage area, c) receiving the first and second versions of the emergency broadcast message at a mobile satellite television within the first portion of the coverage area, wherein the mobile satellite television is selectively associated with the first recipient group, d) receiving the first and second versions of the emergency broadcast message at a stationary satellite television within the second portion of the coverage area, wherein the stationary satellite television is selectively associated with the second recipient group, and e) delivering the first version of the emergency broadcast message via the mobile satellite television and the second version of the broadcast message via the stationary satellite television.

In another aspect an apparatus for broadcast message discrimination is provided. In one embodiment, the apparatus includes: a communication network, a first receiving device, and a second receiving device. The communication network to form multiple versions of a broadcast message with version encoding associating each message version with a corresponding recipient group and to transmit the multiple versions of the broadcast message over a coverage area. The first receiving device in operative communication with the communication network to receive the multiple versions of the broadcast message. The first receiving device is selectively associated with one of at least a first recipient group and a second recipient group to deliver the corresponding message version. The second receiving device in operative communication with the communication network to receive the multiple versions of the broadcast message. The second receiving device is selectively associated with one of at least the first recipient group and the second recipient group to deliver the corresponding message version.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a global perspective view of an exemplary embodiment of an uplink transmission for a satellite communication system;

FIG. 2 is a global perspective view of an exemplary embodiment of a downlink transmission for a satellite communication system;

FIG. 3 is a global perspective view of an exemplary coverage area for an exemplary commercial satellite television service;

FIG. 4 is a global perspective view of an exemplary embodiment of a satellite communication system with a global coverage area;

FIG. 5 is a functional diagram of an exemplary embodiment of a communication system;

FIG. 6 is a flow chart of an exemplary embodiment of a process for broadcast message discrimination;

FIG. 7 is a block diagram of an exemplary embodiment of a communication system;

FIG. 8 is a block diagram of an exemplary embodiment of a receiving device for a communication system; and

FIG. 9 is a flow chart of another exemplary embodiment of a process for broadcast message discrimination.

### DETAILED DESCRIPTION

Various embodiments of communications systems implementing techniques for broadcast message discrimination are described herein. Commercially-available receiving devices, such as televisions (TVs), radios, telephones, computers, and like devices, may be adapted to implement broadcast message discrimination techniques. Next generation receiving devices may include features that implement techniques for broadcast message discrimination. While various exemplary receiving devices are identified herein, the broadcast message discrimination scheme can be applied to any receiving device capable of receiving broadcast messages from a communication system.

In one embodiment, the receiving device may be programmed with a data entry of the local zip or postal code. The broadcast message may be sent from a satellite and may include either no code or a list of such codes related to the message or specific versions of the message. If the broadcast message has no code, the message may be delivered to users by all receiving devices. Similarly, if the receiving device is not equipped or setup for broadcast message discrimination, the message may be delivered to users. If the broadcast message contains one or more zip or postal codes and there is no match with the code stored in the receiving device, the receiving device may suppress delivery of the message. For a localized crisis, authorities may desire to send variants of the message depending, for example, on the location of the receiving device (or users). For example, in a first area the message may be “STAY IN YOUR HOUSE,” in a second area the message may be “EVACUATE IMMEDIATELY BY DRIVING EAST,” in a third area the message may be “EVACUATE IMMEDIATELY BY DRIVING WEST,” and in other areas the message may be “STANDBY FOR FURTHER INSTRUCTIONS.” For portable receiving devices, the device may include global positioning system (GPS) receiver and logic to query the GPS receiver for position information and conversion to an appropriate code (e.g., local zip or postal code) for the discrimination function. The GPS receiver may receive position information from any GPS satellites within line-of-sight and calculate its position in reference to the Earth surface. The GPS satellites may be arranged in a constellation that forms a GPS system that provides global coverage.

These broadcast message discrimination techniques and other techniques described below may increase the practicality and value of broadcast messages in large scale communication systems. For example, receiving devices may perform the discrimination function on early warning messages from geosynchronous satellites to provide a localized warning to appropriate segments of the population without creating panic or false alarms in other segments of the population.

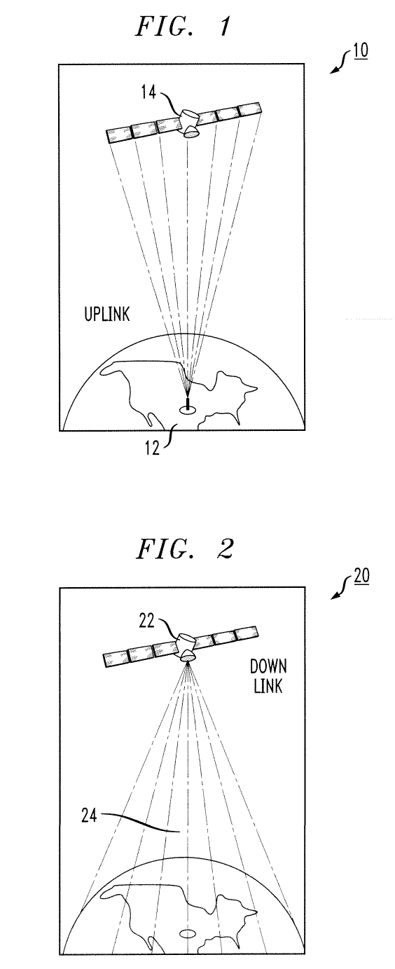

Referring now to the drawings wherein the showings are for purposes of illustrating the exemplary embodiments only and not for purposes of limiting the claimed subject matter, FIG. 1 depicts an exemplary embodiment of an uplink transmission 10 of a broadcast message or another type of message for a satellite communication system. An Earth station 12 may transmit the broadcast message to a satellite 14.

The satellite communication system may include a single extraterrestrial satellite or a constellation of satellites orbiting the Earth. The satellites may be in geostationary orbit or any other type of orbit. Satellites that are in geostationary orbit appear to be stationary in the sky to an observer on the ground. The satellites may be in high Earth orbit (HEO), medium Earth orbit (MEO), or low Earth orbit (LEO). Satellite orbits may be circular, elliptic, hyperbolic, parabolic, or similar geometric variations.

With reference to FIG. 2, an exemplary embodiment of a downlink transmission 20 for a satellite communication system. A satellite 22, having received an uplink, may amplify the broadcast message, shift the broadcast message to a lower frequency, couple the broadcast message to an antenna, and transmit the broadcast message in the downlink transmission toward the Earth over a coverage area 24. The broadcast message referred to in conjunction with FIGS. 1 and 2 may include coding or encoding as described herein to relate the message or specific versions of the message to corresponding recipient groups within the coverage area.

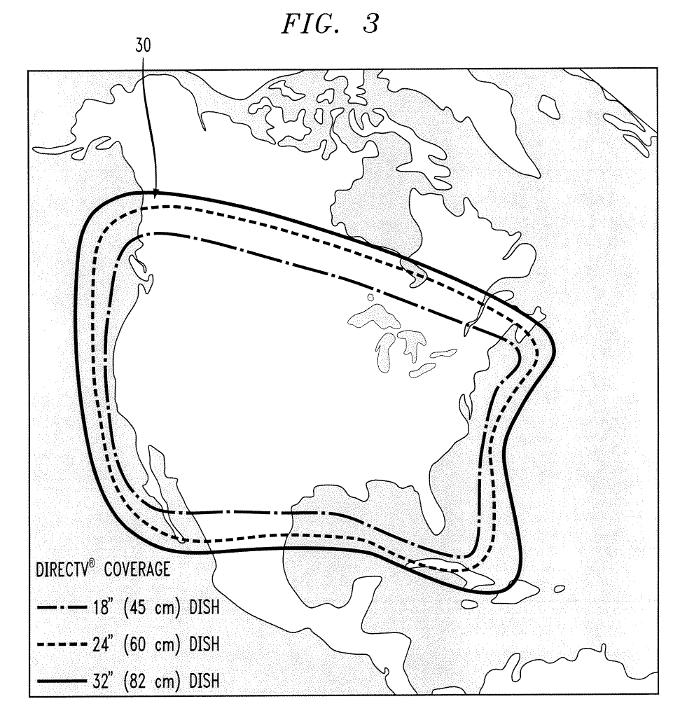

With reference to FIG. 3, the coverage area 30 for DIRECTV® satellite television service from DIRECTV® Group, Inc. of El Segundo, Calif. is shown for the continental United States. Satellite television services such as this may be provided by a satellite communication system that includes one or more geostationary satellites that focus transmission beams toward the desired coverage area. Subscribers within the coverage area may sign up for the DIRECTV® satellite television service, install a compatible satellite television receiver, and pay fees according to service plans. Messages broadcast by such satellite television services may include coding or encoding as described herein to relate the message or specific versions of the message to corresponding subscriber groups within the coverage area. Satellite television receivers used by the subscribers may be programmed with coding or encoding as described herein based on geographic location, service plan, or some other parameter that discriminates subscriber groups within the overall subscriber base for the coverage area.

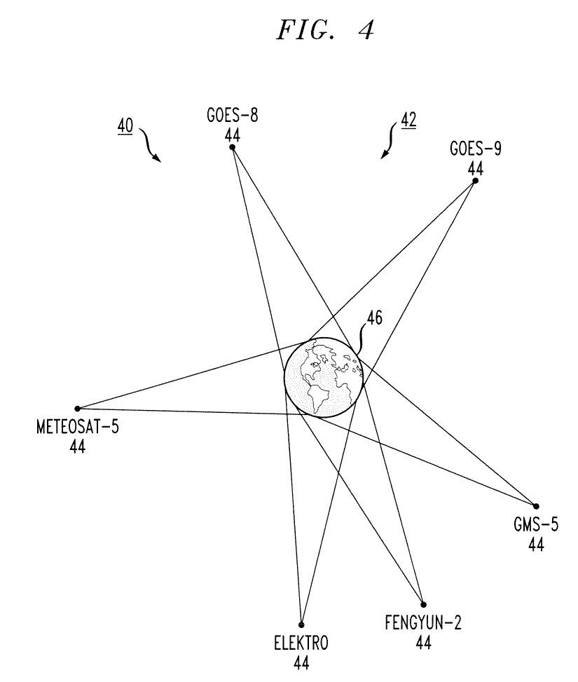

With reference to FIG. 4, an exemplary embodiment of a satellite communication system 40 includes a satellite constellation 42 with a plurality of geostationary satellites 44 arranged to provide global coverage anywhere on Earth 46. Messages broadcast by such a satellite communication system may include coding or encoding as described herein to relate the message or specific versions of the message to corresponding users or subscribers within the coverage area. Receiving devices used by the users or subscribers may be programmed with coding or encoding as described herein based on geographic location, service plan, or some other parameter that discriminates recipient groups around the world.

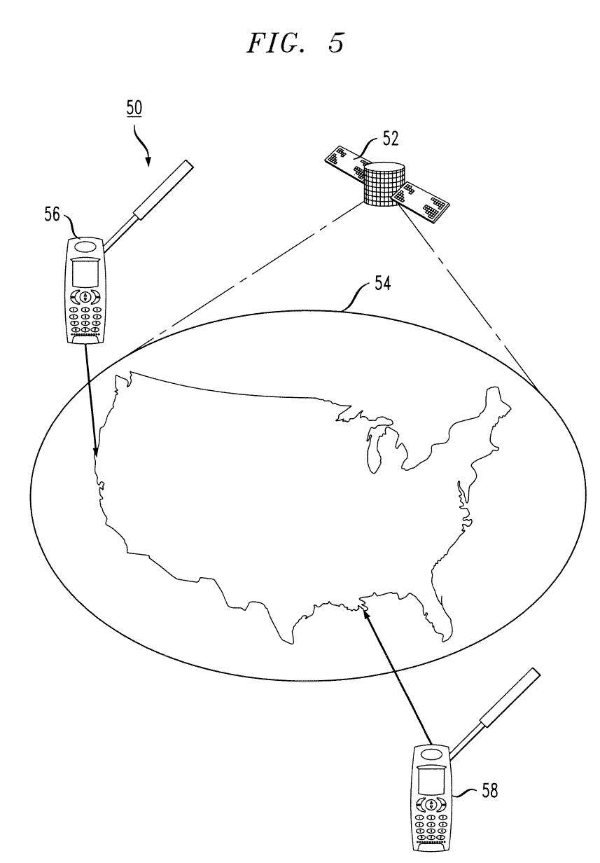

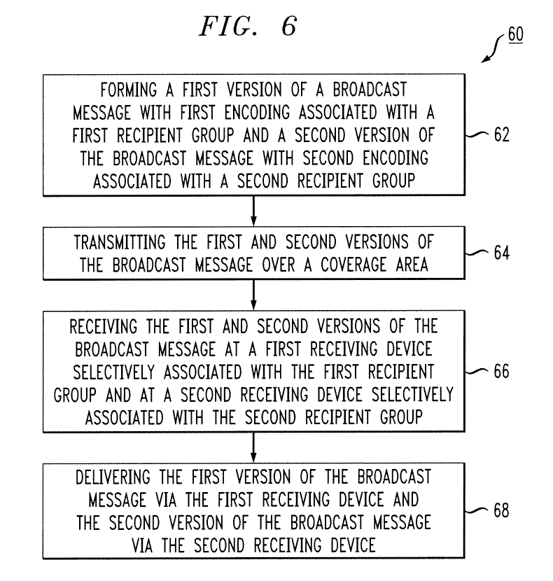

With reference to FIG. 5, an exemplary embodiment of a communication system 50 that implements broadcast message discrimination may include a satellite 52 with a coverage area 54 that encompasses the continental United States. A first mobile receiving device 56 may be used by a first subscriber that normally resides in San Francisco, Calif. A second mobile receiving device 58 may be used by a second subscriber that normally resides in New Orleans, La. Of course, there may be many more subscribers and many more receiving devices within the coverage. Other receiving devices may be mobile or stationary.

The receiving device may include a television, radio, telephone, computer, or another suitable communication device. Some common examples of receiving devices may include a personal digital assistant (PDA), a BlackBerry®, an iPod®, or an iPhone® equipped with an antenna compatible with the corresponding satellite from which messages are to be received. The communication system 40 may utilize S band, Kᵤ band, K band, or another suitable electromagnetic frequency band for transmissions.

The communication system 50 may include one or more terrestrial antennas, such as those typically used in conjunction with metropolitan area networks (MANs), wide area networks (WANs), cellular telephone networks, broadcast television stations, or broadcast radio stations. Of course, another embodiment of the communication system may use terrestrial antennas in place of satellite-based extraterrestrial antennas. For example, IEEE 802.16 wireless computer networks (i.e., WiMAX networks) with one or more terrestrial antennas providing network access to wireless computer devices within a metropolitan-sized area may implement broadcast message discrimination features described herein. Similarly, broadcast message discrimination features described herein may be implemented by a cellular telephone network and corresponding mobile devices.

In other embodiments, a communication system may implement broadcast message discrimination features described herein across wired communication networks, such as landline telephone networks or cable television networks. Of course, any combination of wired and wireless networks may be interconnected to form the communication network for a communication system that implements broadcast message discrimination features described herein.

With continued reference to FIG. 5, the first and second receiving devices 56, 58 may have a programmable parameter associated with broadcast message encoding and an input device that permits subscribers to set or modify the programmable parameter to associate the corresponding receiving device with a desired subscriber group among the overall subscribers to the communication network or broadcast message service. For example, the first subscriber may set the encoding parameter for the first receiving device 56 to 94105 (i.e., San Francisco zip code) and the second subscriber may set the encoding parameter for the second receiving device 58 to 70129 (i.e., New Orleans zip code). The communication system 50 may form a broadcast message warning subscribers of a hurricane in the Gulf of Mexico approaching New Orleans with encoding that lists various zip codes in the New Orleans area, including 70129, as desired recipient groups. The satellite 52 may transmit the broadcast message over the continental United States. The second receiving device 56 may receive and deliver the broadcast message because the encoding includes 94105. Conversely, the first receiving device 56 may receive and suppress the broadcast message because the encoding does not list 94105.

The communication system 50 may form multiple versions of the broadcast message with the hurricane warning with different content and different encoding if multiple recipient classes or groups should receive different content. For example, a first message version may be a warning to subscribers in the New Orleans area to “EVACUATE IMMEDIATELY.” Encoding for the first message may list various zip codes for the New Orleans area. A second message version may be a warning to subscribers along the Texas coastal area to “SEEK LOCAL SHELTER.” Encoding for the second message may list various zip codes for the Texas coastal area. A third message version may be a warning to subscribers along the Florida Gulf coast area to “SECURE PROPERTIES AND STANDBY.” Encoding for the third message may list various zip codes for the Florida Gulf coast area. A similar scenario could be described for a broadcast message with an earthquake warning for subscribers in the San Francisco area.

The second mobile receiving device 58 may include a GPS receiver and logic to periodically retrieve geographic position information from the GPS receiver, convert the GPS position information to an appropriate encoding parameter value, and set or update the encoding parameter to the value corresponding to the geographic location of the receiving device. In the New Orleans hurricane example, initially, the second mobile receiving device 58 would receive all versions of the message and deliver the first version. If the second subscriber evacuates the New Orleans area and travels west, the encoding parameter in the second mobile receiving device 58 may be updated as the second subscriber moves from one zip code area to another. If the second subscriber entered the Texas coastal area, the second mobile receiving device 58 would receive all versions of the message and deliver the second version. If the second subscriber continues west beyond the Texas coastal area, the second mobile receiving device 58 would receive all versions of the message and suppress the message.

In other embodiments, the encoding may be used to permit identification of recipient groups based on geography with higher or lower resolution than the five digit zip code. This may be accomplished by using multiple encoding parameters in various combinations or by altering the encoding parameter. For example, the encoding can be based on various combinations of traditional addressing, such as street, city, state, zip code, and country. The zip code itself can be used to alter resolution of geographic areas for encoding. For example, the first digit represents a large contiguous geographic area, the first two digits a smaller contiguous geographic area which is a subset of the large area, the first three digits an even smaller contiguous geographic area which is a subset of the two digit area, etc. The four digit zip code extension can be used for encoding where an even finer resolution is desired for distinguishing recipient groups. For example, the applicability of some information, such as information regarding liquid or chemical spills, fires, hostage situations, and highway conditions may be quite localized. Use of zip code extensions for encoding allows the broadcast message may to be discriminated down to an area of a street or several streets for these circumstances.

In other embodiments, other types of position determining techniques may be implemented to update the encoding parameter. For example, communication systems with multiple extraterrestrial or terrestrial antennas in communication with the receiving device may utilize triangulation principles to calculate position based on signal strength from each antenna. Certain cellular communication systems can implement position determining features so that positions of compatible mobile devices can be determined. If, for example, the first mobile receiving device 56 does not include a GPS receiver or another type of position determining feature, the first subscriber may update the encoding parameter when traveling to another zip code.

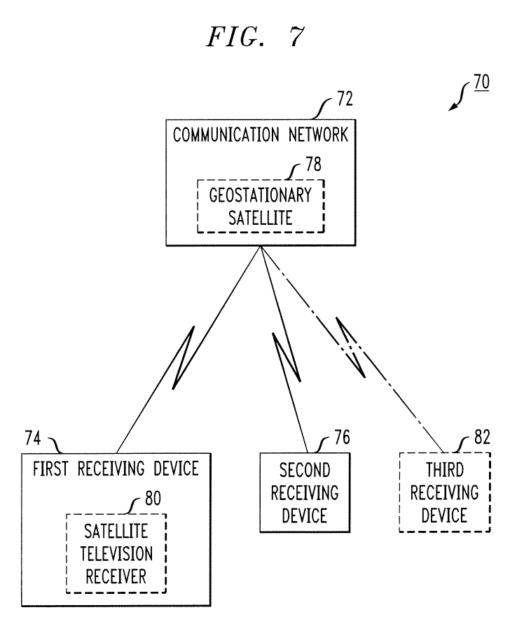

With reference to FIG. 6, an exemplary embodiment of a process 60 for broadcast message discrimination begins at 62 where a first version of a broadcast message may be formed with first encoding associated with a first recipient group and a second version of the broadcast message may be formed with second encoding associated with a second recipient group. At 64, the first and second versions of the broadcast message may be transmitted over a coverage area. Next, the first and second versions of the broadcast message may be received at a first receiving device selectively associated with the first recipient group and at a second receiving device selectively associated with the second recipient group (66). At 68, the first version of the broadcast message may be delivered via the first receiving device and the second version of the broadcast message may be delivered via the second receiving device.

In another embodiment, the process 60 may include receiving the first and second versions of the broadcast message at a third receiving device associated with a third recipient group. In this embodiment, delivery of the first and second versions of the broadcast message via the third receiving device may be suppressed.

In still another embodiment, the process 60 may receiving the first and second versions of the broadcast message at a third receiving device not associated with a specific recipient group. In the embodiment being described, the first version of the broadcast message may be delivered via the third receiving device. For this embodiment, at least one of the first and second encoding in 62 may prioritize the first version over the second version.

In yet another embodiment, the process 60 may include receiving the first and second versions of the broadcast message at a third receiving device not associated a specific recipient group. In this embodiment, the first and second versions of the broadcast message may be delivered via the third receiving device.

In another embodiment, the process 60 may include setting a first programmable parameter in the first receiving device to a value associating the first receiving device with the first recipient group. In still

In still another embodiment, the process 60 may include periodically determining a geographic location of the first receiving device. In this embodiment, a first programmable parameter in the first receiving device may be set to a value associating the first receiving device with a select recipient group based at least in part on the determined geographic location. For this embodiment, the first recipient group may be associated with a first geographic portion of the coverage area, the second recipient group may be associated with a second geographic portion of the coverage area, and the first receiving device may be within the first geographic portion during at least one of the receiving in 66 and the delivering in 68. In the embodiment being described, the process 60 may also include periodically receiving geographic position signals from a global satellite positioning system at the first receiving device. In this embodiment, the determined geographic location determined may be is based at least in part on the received geographic position signals.

With reference to FIG. 7, an exemplary embodiment of a communication system 70 for broadcast message discrimination may include a communication network 72, a first receiving device 74, and a second receiving device 76. The communication network 72 may form multiple versions of a broadcast message with version encoding associating each message version with a corresponding recipient group. The multiple versions of the broadcast message may be transmitted by the communication network 72 over a coverage area. The first receiving device 74 may be in operative communication with the communication network 72 to receive the multiple versions of the broadcast message. The first receiving device 74 may be selectively associated with a first recipient group or a second recipient group to deliver the corresponding message version. The second receiving device 76 may be operative communication with the communication network 72 to receive the multiple versions of the broadcast message. The second receiving device 76 may be selectively associated with the first recipient group or the second recipient group to deliver the corresponding message version.

In another embodiment, the communication network 72 may include a geostationary satellite 78 to transmit the multiple versions of the broadcast message over the coverage area. In the embodiment being described, the first receiving device 74 may include a satellite television receiver 80 in communication with the geostationary satellite 78 to receive the multiple versions of the broadcast message. For this embodiment, the communication system 70 may also include a third receiving device 82 in operative communication with the communication network 72 to receive the multiple versions of the broadcast message. In the embodiment being described, the third receiving device 82 may be selectively associated with a third recipient group and the multiple versions of the broadcast message may not include a message version associated with the third recipient group. Under these circumstances, the third receiving device 82 may suppress delivery of the broadcast message.

In yet another embodiment, the communication system 70 may include a third receiving device 82 in operative communication with the communication network 72 to receive the multiple versions of the broadcast message. In this embodiment, the third receiving device 82 may not be associated with a specific recipient group and may deliver a priority version of the broadcast message. For this embodiment, the version encoding by the communication network 72 may identify the priority version among the multiple versions of the broadcast message.

In still another embodiment, the communication system 70 may include a third receiving device 82 in operative communication with the communication network 72 to receive the multiple versions of the broadcast message. In this embodiment, the third receiving device 82 may not be associated with a specific recipient group and may deliver the multiple versions of the broadcast message.

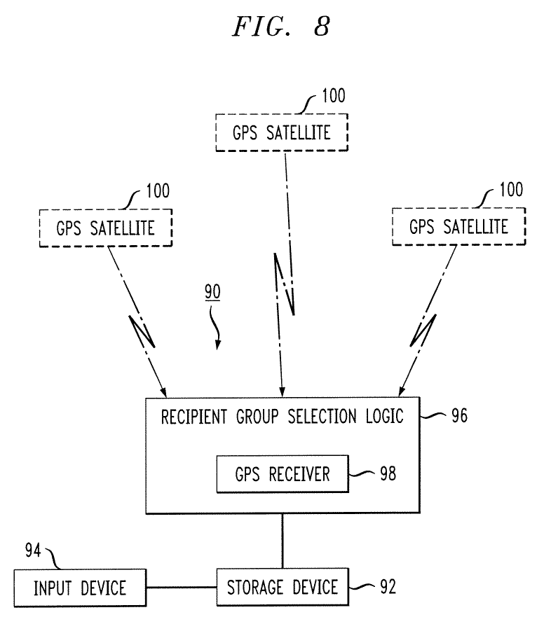

With reference to FIG. 8, an exemplary embodiment of a receiving device 90 may include a storage device 92 and an input device 94. The storage device 92 may store a first programmable parameter. The input device 94 may be used to manually set the first programmable parameter to a value associated with a select recipient group. In another embodiment, the receiving device 90 may also include a recipient group selection logic 96 to periodically determine a geographic location of the first receiving device and set the first programmable parameter to a value associated with a select recipient group based at least in part on the determined geographic location. In this embodiment, the recipient group selection logic 96 may include a global positioning system receiver 98 to periodically receive geographic position signals from a plurality of global positioning system satellites 100. The determined geographic location may be based at least in part on the received geographic position signals.

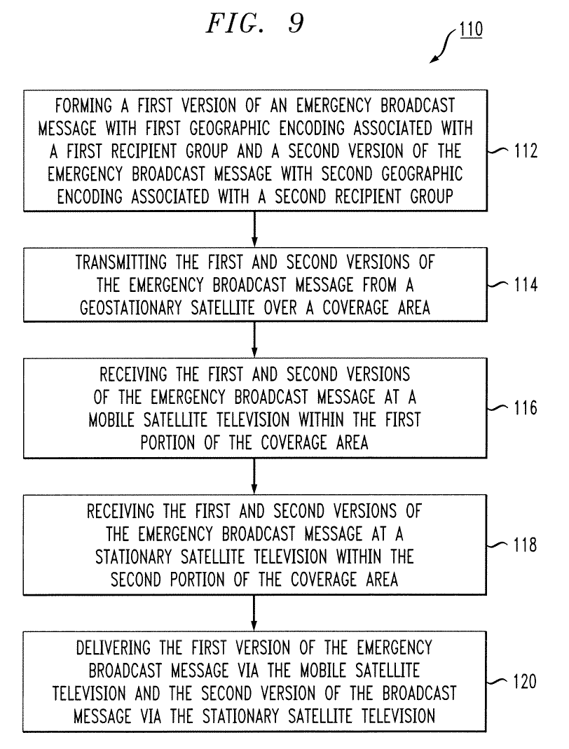

With reference to FIG. 9, an exemplary embodiment of a process 110 for broadcast message discrimination may begin at 112 where a first version of an emergency broadcast message may be formed with first geographic encoding associated with a first recipient group and a second version of the emergency broadcast message may be formed with second geographic encoding associated with a second recipient group. At 114, the first and second versions of the emergency broadcast message may be transmitted from a geostationary satellite over a coverage area. The first geographic encoding and first recipient group may be associated with a first portion of the coverage area. Similarly, the second geographic encoding and second recipient group may be associated with a second portion of the coverage area. Next, the first and second versions of the emergency broadcast message may be received at a mobile satellite television within the first portion of the coverage area (116). The mobile satellite television may be selectively associated with the first recipient group. At 118, the first and second versions of the emergency broadcast message may be received at a stationary satellite television within the second portion of the coverage area. The stationary satellite television may be selectively associated with the second recipient group. Next, the first version of the emergency broadcast message may be delivered via the mobile satellite television and the second version of the broadcast message may be delivered via the stationary satellite television (120).

In another embodiment, the process 110 may include receiving the first and second versions of the emergency broadcast message at a third satellite television within the coverage area. The third satellite television may be selectively associated with a third recipient group. In this embodiment, delivery of the first and second versions of the emergency broadcast message via the third satellite television may be suppressed.

In yet another embodiment, the process 110 may include periodically receiving geographic position signals from a global satellite positioning system at the mobile satellite television. In the embodiment being described, a geographic location of the mobile satellite television may be periodically determined based at least in part the geographic position signals. For this embodiment, a first programmable parameter in the mobile satellite television may be set to a value associating the mobile satellite television with a select recipient group based at least in part on the determined geographic location.

In still another embodiment, the process 110 may include manually setting a first programmable parameter in the stationary satellite television to a value associating the stationary satellite television with the second recipient group based at least in part on a geographic location of the stationary satellite television within the coverage area.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for broadcast message discrimination, the method including:
a) forming a first version of a broadcast message with first encoding associated with a first recipient group and a second version of the broadcast message with second encoding associated with a second recipient group;
b) transmitting the first and second versions of the broadcast message over a coverage area;
c) receiving the first and second versions of the broadcast message at a first receiving device selectively associated with the first recipient group and at a second receiving device selectively associated with the second recipient group; and
d) delivering the first version of the broadcast message via the first receiving device and the second version of the broadcast message via the second receiving device.

2. The method of claim 1, further including:
e) receiving the first and second versions of the broadcast message at a third receiving device associated with a third recipient group; and
f) suppressing delivery of the first and second versions of the broadcast message via the third receiving device.

3. The method of claim 1, further including:
e) receiving the first and second versions of the broadcast message at a third receiving device not associated with a specific recipient group; and
f) delivering the first version of the broadcast message via the third receiving device, wherein at least one of the first and second encoding in a) prioritizes the first version over the second version.

4. The method of claim 1, further including:
e) receiving the first and second versions of the broadcast message at a third receiving device not associated a specific recipient group; and
f) delivering the first and second versions of the broadcast message via the third receiving device.

5. The method of claim 1, further including:
e) setting a first programmable parameter in the first receiving device to a value associating the first receiving device with the first recipient group.

6. The method of claim 1, further including:
e) periodically determining a geographic location of the first receiving device; and
f) setting a first programmable parameter in the first receiving device to a value associating the first receiving device with a select recipient group based at least in part on the geographic location determined in e);
wherein the first recipient group is associated with a first geographic portion of the coverage area, the second recipient group is associated with a second geographic portion of the coverage area, and the first receiving device is within the first geographic portion during at least one of the receiving in c) and the delivering in d).

7. The method of claim 6, further including:
g) periodically receiving geographic position signals from a global satellite positioning system at the first receiving device;
wherein the geographic location determined in e) is based at least in part on the geographic position signals received in g).

8. An apparatus for broadcast message discrimination, including:
a communication network to form multiple versions of a broadcast message with version encoding associating each message version with a corresponding recipient group and to transmit the multiple versions of the broadcast message over a coverage area;
a first receiving device in operative communication with the communication network to receive the multiple versions of the broadcast message, wherein the first receiving device is selectively associated with one of at least a first recipient group and a second recipient group to deliver the corresponding message version; and
a second receiving device in operative communication with the communication network to receive the multiple versions of the broadcast message, wherein the second receiving device is selectively associated with one of at least the first recipient group and the second recipient group to deliver the corresponding message version.

9. The apparatus of claim 8, the communication network including:
a geostationary satellite to transmit the multiple versions of the broadcast message over the coverage area.

10. The apparatus of claim 9, the first receiving device including:
a satellite television receiver in communication with the geostationary satellite to receive the multiple versions of the broadcast message.

11. The apparatus of claim 10, further including:
a third receiving device in operative communication with the communication network to receive the multiple versions of the broadcast message, wherein the third receiving device is selectively associated with a third recipient group and the multiple versions of the broadcast message do not include a message version associated with the third recipient group, the third receiving device suppressing delivery of the broadcast message.

12. The apparatus of claim 8, further including:
a third receiving device in operative communication with the communication network to receive the multiple versions of the broadcast message, wherein the third receiving device is not associated with a specific recipient group and delivers a priority version of the broadcast message;
wherein the version encoding by the communication network identifies the priority version among the multiple versions of the broadcast message.

13. The apparatus of claim 8, further including:
a third receiving device in operative communication with the communication network to receive the multiple versions of the broadcast message, wherein the third receiving device is not associated with a specific recipient group and delivers the multiple versions of the broadcast message.

14. The apparatus of claim 8, the first receiving device including:
a storage device to store a first programmable parameter; and
an input device to manually set the first programmable parameter to a value associated with a select recipient group.

15. The apparatus of claim 8, the first receiving device including:
a storage device to store a first programmable parameter; and
a recipient group selection logic to periodically determine a geographic location of the first receiving device and set the first programmable parameter to a value associated with a select recipient group based at least in part on the determined geographic location.

16. The apparatus of claim 15, the recipient group selection logic including:
a global positioning system receiver to periodically receive geographic position signals from a plurality of global positioning system satellites;
wherein the determined geographic location is based at least in part on the received geographic position signals.

17. A method for broadcast message discrimination, the method including:
a) forming a first version of an emergency broadcast message with first geographic encoding associated with a first recipient group and a second version of the emergency broadcast message with second geographic encoding associated with a second recipient group;
b) transmitting the first and second versions of the emergency broadcast message from a geostationary satellite over a coverage area, wherein the first geographic encoding and first recipient group are associated with a first portion of the coverage area and the second geographic encoding and second recipient group are associated with a second portion of the coverage area;
c) receiving the first and second versions of the emergency broadcast message at a mobile satellite television within the first portion of the coverage area, wherein the mobile satellite television is selectively associated with the first recipient group;
d) receiving the first and second versions of the emergency broadcast message at a stationary satellite television within the second portion of the coverage area, wherein the stationary satellite television is selectively associated with the second recipient group; and
e) delivering the first version of the emergency broadcast message via the mobile satellite television and the second version of the broadcast message via the stationary satellite television.

18. The method of claim 17, further including:
f) receiving the first and second versions of the emergency broadcast message at a third satellite television within the coverage area, wherein the third satellite television is selectively associated with a third recipient group; and
g) suppressing delivery of the first and second versions of the emergency broadcast message via the third satellite television.

19. The method of claim 17, further including:
f) periodically receiving geographic position signals from a global satellite positioning system at the mobile satellite television;
g) periodically determining a geographic location of the mobile satellite television based at least in part the geographic position signals; and
h) setting a first programmable parameter in the mobile satellite television to a value associating the mobile satellite television with a select recipient group based at least in part on the geographic location determined in g).

20. The method of claim 17, further including:
f) manually setting a first programmable parameter in the stationary satellite television to a value associating the stationary satellite television with the second recipient group based at least in part on a geographic location of the stationary satellite television within the coverage area.
